(19) United States
(12) Patent Application Publication
(10) Pub. No.: US 2025/0034366 A1
(43) Pub. Date: Jan. 30, 2025

(54) Freshwater Biodegradable Mixed Ester Cellulose Esters

(71) Applicant: Eastman Chemical Company, Kingsport, TN (US)

(72) Inventors: Jessica Price Evans, Kingsport, TN (US); Wesley Wayne McConnell, Gray, TN (US); Bin Wang, Kingsport, TN (US); Myungman Kim, Johnson City, TN (US)

(73) Assignee: Eastman Chemical Company, Kingsport, TN (US)

(21) Appl. No.: 18/709,118

(22) PCT Filed: Nov. 11, 2022
(86) PCT No.: PCT/US2022/049645

§ 371 Date: May 10, 2024

Related U.S. Application Data
(60) Provisional application No. 63/365,202, filed on May 24, 2022.
(60) Provisional application No. 63/264,990, filed on Dec. 6, 2021.
(60) Provisional application No. 63/263,952, filed on Nov. 12, 2021.

(51) Int. Cl. C08L 1/14; C08K 5/11; C08K 5/52

(52) U.S. Cl. CPC C08L 1/14; C08K 5/11; C08K 5/52; C08L 2201/06; C08L 2203/206

(57) ABSTRACT

The present application discloses mixed cellulose esters that are freshwater biodegradable. The present application also discloses compositions, articles, beads and films (e.g. reverse dispersion quarter waveplate) made from the mixed cellulose esters.

### BACKGROUND

In natural environments, conventional non-biodegradable plastics mechanically break down into small pieces of plastics, called microplastics, that persists in the environment. Some single use plastics such as microbeads used in health and beauty products and lint microfibers from the laundry are other sources of microplastics. Due to their size, these microplastics end up in natural water bodies. To reduce microplastics generation, it is desirable to use plastics that are freshwater biodegradable.

Applicants disclose mixed ester cellulose acetate propionate and mixed ester cellulose acetate butyrate polymers that have been designed with the appropriate mix of acetyl, propionyl/butyrate, and hydroxyl content to biodegrade in freshwater environments. The mixed ester cellulose esters disclosed herein are useful in preparing films, microbeads, and other articles that are freshwater biodegradable.

### SUMMARY OF THE INVENTION

The present application discloses a mixed ester cellulose ester (“MCE”), comprising:
(1) a plurality of acetyl substituents;
(2) a plurality of propionyl substituents; and
(3) a plurality of hydroxyl substituents,
wherein:
   the CE has a degree of substitution for the acetyl substituents (“DS_{Ac}”) is from 0.6 to 1.9,
   the CE has a degree of substitution for the propionyl substituents (“DS_{Pr}”) is from 0.5 to 0.95, the CE has a degree of substitution for the hydroxyl substituents
   (“DS_{OH}”) is from 0.7 to 1.4.

The present application also discloses a mixed cellulose ester (“MCE”), comprising:
(1) a plurality of acetyl substituents;
(2) a plurality of propionyl substituents; and
(3) a plurality of hydroxyl substituents,
wherein:
   the MCE has an average degree of substitution for the acetyl substituents (“DS_{Ac}”) is from 0.6 to 1.2,
   the MCE has an average degree of substitution for the propionyl substituents (“DS_{Pr}”) is from 1.05 to 1.4, and
   the MCE has an average degree of substitution for the hydroxyl substituents (“DS_{OH}”) is from 0.7 to 1.4.

The present application also discloses a mixed cellulose ester (“MCE”), comprising:
(1) a plurality of acetyl substituents;
(2) a plurality of butyryl substituents; and
(3) a plurality of hydroxyl substituents,
wherein:
   the MCE has an average degree of substitution for the acetyl substituents (“DS_{Ac}”) is from 0.9 to 2.4,
   the MCE has an average degree of substitution for the butyryl substituents (“DS_{Bu}”) is from 0.1 to 1.1,
   the MCE has an average degree of substitution for the hydroxyl substituents (“DS_{OH}”) is from 0.6 to 1.5.

The present application also discloses compositions, articles, beads, bead compositions and films made from the mixed ester compositions disclosed herein.

The present application also discloses cellulose ester particles formed from a cellulose ester composition comprising:
(I) a mixed cellulose ester (“MCE”) comprising:
   (1) a plurality of acetyl substituents;
   (2) a plurality of (C₂₋₃)alkyl-CO— substituents; and
   (3) a plurality of hydroxyl substituents,
   wherein:
   the MCE has an average degree of substitution for the acetyl substituents (“DS_{Ac}”) that is from 0.6 to 2.4,
   the MCE has an average degree of substitution for the (C₂₋₃)alkyl-CO— substituents (“DS_{AkCO}”) that is from 0.1 to 1.1,
   the MCE has an average degree of substitution for the hydroxyl substituents (“DS_{OH}”) that is from 0.55 to 1.5; and
(II) a cellulose acetate (“CA”), comprising:
   (1) a plurality of acetyl substituents; and
   (2) a plurality of hydroxyl substituents,
   wherein:
   the CA has an average degree of substitution for the acetyl substituents (“DS_{Ac}”) that is from 1.5 to 2.6,
   the CA has an average degree of substitution for the hydroxyl substituents (“DS_{OH}”) that is from 0.4 to 1.5.

The present application also discloses a dope composition comprising:
(A) a cellulose ester composition:
   (I) a mixed cellulose ester (“MCE”) comprising:
      (1) a plurality of acetyl substituents;
      (2) a plurality of (C₂₋₃)alkyl-CO— substituents; and
      (3) a plurality of hydroxyl substituents,
      wherein:
      the MCE has an average degree of substitution for the acetyl substituents (“DS_{Ac}”) that is from 0.6 to 2.4,
      the MCE has an average degree of substitution for the (C₂₋₃)alkyl-CO— substituents (“DS_{AkCO}”) that is from 0.1 to 1.1,
      the MCE has an average degree of substitution for the hydroxyl substituents (“DS_{OH}”) that is from 0.55 to 1.5, and
   (II) a cellulose acetate (“CA”), comprising:
      (1) a plurality of acetyl substituents; and
      (2) a plurality of hydroxyl substituents,
      wherein:
      the CA has an average degree of substitution for the acetyl substituents (“DS_{Ac}”) that is from 1.5 to 2.6,
      the CA has an average degree of substitution for the hydroxyl substituents (“DS_{OH}”) that is from 0.4 to 1.5; and
(B) a solvent,
   wherein the solvent comprises:
   (1) water,
   (2) (C₁₋₂)alkyl acetate, and
   (3) (C₁₋₅)alkanol,
wherein the dope composition exhibits a viscosity in the range of from 3000 to 9000 cP.

### DETAILED DESCRIPTION OF THE INVENTION

The present invention may be understood more readily by reference to the following detailed description of the invention and the examples provided therein. It is to be understood that this invention is not limited to the specific methods, formulations, and conditions described, as such may vary. It is also to be understood that the terminology used herein is for the purpose of describing particular aspects of the invention only and is not intended to be limiting.

Values may be expressed as “about” or “approximately” a given number. Similarly, ranges may be expressed herein as from “about” one particular value and/or to “about” or another particular value. When such a range is expressed, another aspect includes from the one particular value and/or to the other particular value. Similarly, when values are expressed as approximations, by use of the antecedent “about,” it will be understood that the particular value forms another aspect.

As used herein, the terms “a,” “an,” and “the” mean one or more. As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “includes,” and “include” have the same open-ended meaning as “comprising,” “comprises,” and “comprise” provided above.

“Degree of Substitution” is used to describe the average substitution level of the substituents per anhydroglucose unit (“AGU”). Generally, conventional cellulose contains three hydroxyl groups in each AGU that can be substituted. Therefore, the DS can have a value between 0 and 3. However, low molecular weight cellulose mixed esters can have a total degree of substitution slightly above 3 from end group contributions. Low molecular weight cellulose mixed esters are discussed in more detail subsequently in this disclosure. Because DS is a statistical mean value, a value of 1 does not assure that every AGU has a single substituent. In some cases, there can be unsubstituted anhydroglucose units, some with two and some with three substituents, and more often than not the value will be a noninteger. Total DS is defined as the average number of all of substituents per anhydroglucose unit. The degree of substitution per AGU can also refer to a particular substituent, such as, for example, hydroxyl, acetyl, butyryl, or propionyl. Additionally, the degree of substitution can specify a given hydroxyl based on the carbon unit of the anhydroglucose unit.

When the degree of substitution refers to hydroxyl, i.e, DS_{OH}, the reference is to the average hydroxyl groups per anhydroglucose that are not substituted. As a result, (DS_{OH}) is not used in the calculation of the total degree of substitution.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

The present description uses specific numerical values to quantify certain parameters relating to the invention, where the specific numerical values are not expressly part of a numerical range. It should be understood that each specific numerical value provided herein is to be construed as providing literal support for a broad, intermediate, and narrow range. The broad range associated with each specific numerical value is the numerical value plus and minus 60 percent of the numerical value, rounded to two significant digits. The intermediate range associated with each specific numerical value is the numerical value plus and minus 30 percent of the numerical value, rounded to two significant digits. The narrow range associated with each specific numerical value is the numerical value plus and minus 15 percent of the numerical value, rounded to two significant digits. For example, if the specification describes a specific temperature of 62° F., such a description provides literal support for a broad numerical range of 25° F. to 99° F. (62° F.+/−37° F.), an intermediate numerical range of 43° F. to 81° F. (62° F.+/−19° F.), and a narrow numerical range of 53° F. to 71° F. (62° F.+/−9° F.). These broad, intermediate, and narrow numerical ranges should be applied not only to the specific values, but should also be applied to differences between these specific values. Thus, if the specification describes a first pressure of 110 psia and a second pressure of 48 psia (a difference of 62 psi), the broad, intermediate, and narrow ranges for the pressure difference between these two streams would be 25 to 99 psi, 43 to 81 psi, and 53 to 71 psi, respectively.

Throughout this application, where patents or publications are referenced, the disclosures of these references in their entireties are intended to be incorporated by reference into this application, to the extent they are not inconsistent with the present invention, in order to more fully describe the state of the art to which the invention pertains.

The cellulose esters thus prepared generally comprise the following structure:

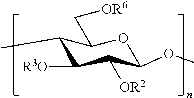

where R², R³, and R⁶ are hydrogen (with the proviso that R², R³, and R⁶ are not hydrogen simultaneously), alkyl-acyl groups, and/or aryl-acyl groups (such as those described above) bound to the cellulose via an ester linkage.

The degree of polymerization (“DP”) of the cellulose esters prepared by these methods can be at least 10. In other embodiments, the DP of the cellulose esters can be at least 50, at least 100, or at least 250. In other embodiments, the DP of the cellulose esters can be in the range of from about 5 to about 100, or in the range of from about 10 to about 50.

Acylating reagents suitable for use herein can include, but are not limited to, alkyl or aryl carboxylic anhydrides, carboxylic acid halides, and/or carboxylic acid esters containing the above-described alkyl or aryl groups suitable for use in the acyl substituents of the substituted cellulose esters described herein. Examples of suitable carboxylic anhydrides include, but are not limited to, acetic anhydride, propionic anhydride, butyric anhydride, pivaloyl anhydride, benzoic anhydride, and naphthoyl anhydride. Examples of carboxylic acid halides include, but are not limited to, acetyl, propionyl, butyryl, pivaloyl, benzoyl, and naphthoyl chlorides or bromides. Examples of carboxylic acid esters include, but are not limited to, acetyl, propionyl, butyryl, pivaloyl, benzoyl and naphthoyl methyl esters. In one or more embodiments, the acylating reagent can be one or more carboxylic anhydrides selected from the group consisting of acetic anhydride, propionic anhydride, butyric anhydride, pivaloyl anhydride, benzoyl anhydride, and naphthoyl anhydride.

The present application discloses, in a first aspect, a mixed ester cellulose ester (“MCE”), comprising: (1) a plurality of acetyl substituents; (2) a plurality of propionyl substituents; and (3) a plurality of hydroxyl substituents, wherein: the MCE has an average degree of substitution for the acetyl substituents (“DS_{Ac}”) is from 0.6 to 2.3, the MCE has an average degree of substitution for the propionyl substituents (“DS_{Pr}”) is from 0.1 to 0.95, the MCE has an average degree of substitution for the hydroxyl substituents (“DS_{OH}”) is from 0.5 to 1.5.

In one embodiment or in combination with any other embodiment, class or subclass of this first aspect, wherein the DS_{Ac} is from 0.6 to 2.2, or 0.6 to 2.1, or 0.6 to 2.0, or 0.6 to 1.9, or 0.6 to 1.8, or 0.7 to 2.3, or 0.7 to 2.2, or 0.7 to 2.1, or 0.7 to 2.0, or 0.7 to 1.9, or 0.8 to 2.3, or 0.8 to 2.2, or 0.8 to 2.1, or 0.8 to 2.0, or 0.8 to 1.9, or 0.9 to 2.3, or 0.9 to 2.2, or 0.9 to 2.1, or 0.9 to 2.0, or 0.9 to 1.9, or 1.0 to 2.3 or 1.0 to 2.2, or 1.0 to 2.1, or 1.0 to 2.0, or 1.0 to 1.9, or 1.1 to 2.3, or 1.1 to 2.2, or 1.1 to 2.1, or 1.1 to 2.0, or 1.1 to 1.9, or 1.2 to 2.3 or 1.2 to 2.2, or 1.2 to 2.1, or 1.2 to 2.0, or 1.2 to 1.9, or 0.6 to 1.5, or 0.6 to 1.3, or 0.6 to 1.1, or 0.6 to 0.9 or 0.7 to 1.5, or 0.7 to 1.3, or 0.7 to 1.1, or 0.7 to 0.9.

In one embodiment or in combination with any other embodiment, class or subclass of this first aspect, wherein the DS_{Pr} is from 0.1 to 0.9, or 0.1 to 0.85, or 0.1 to 0.8, or 0.1 to 0.75, or 0.1 to 0.7, or 0.1 to 0.6 or 0.1 to 0.5, or 0.1 to 0.4, or 0.15 to 0.95, or 0.15 to 0.9, or 0.15 to 0.85, or 0.15 to 0.8, or 0.15 to 0.75, or 0.15 to 0.7, or 0.15 to 0.65, or 0.2 to 0.95, or 0.2 to 0.9, or 0.2 to 0.85, or 0.2 to 0.8, or 0.2 to 0.75, or 0.2 to 0.7, or 0.2 to 0.65, 0.25 to 0.95, or 0.25 to 0.9, or 0.25 to 0.85, or 0.25 to 0.8, or 0.25 to 0.75, or 0.25 to 0.7, or 0.25 to 0.65, or 0.3 to 0.95, or 0.3 to 0.9, or 0.3 to 0.85, or 0.3 to 0.8, or 0.3 to 0.75, or 0.3 to 0.7, or 0.3 to 0.65, or 0.35 to 0.95, or 0.35 to 0.9, or 0.35 to 0.85, or 0.35 to 0.8, or 0.35 to 0.75, or 0.35 to 0.7, or 0.35 to 0.65, or 0.4 to 0.95, or 0.4 to 0.9, or 0.4 to 0.85, or 0.4 to 0.8, or 0.4 to 0.75, or 0.4 to 0.7, or 0.4 to 0.65, or 0.45 to 0.95, or 0.45 to 0.9, or 0.45 to 0.85, or 0.45 to 0.8, or 0.45 to 0.75, or 0.45 to 0.7, or 0.45 to 0.65, or 0.5 to 0.95, or 0.5 to 0.9, or 0.5 to 0.85, or 0.5 to 0.8, or 0.5 to 0.75, or 0.5 to 0.7, or 0.5 to 0.65, or 0.1 to 0.9, or 0.1 to 0.85, or 0.1 to 0.8.

In one embodiment or in combination with any other embodiment, class or subclass of this first aspect, wherein the (DS_{OH}) is from 0.5 to 1.5, or 0.5 to 1.45, or 0.5 to 1.40, or 0.5 to 1.35, or 0.5 to 1.30, or 0.5 to 1.25, or 0.5 to 1.2, or 0.5 to 1.15, or 0.5 to 1.1, or 0.5 to 1.05, or 0.5 to 1.0, or 0.5 to 0.95 or 0.5 to 0.9, or 0.55 to 1.5, or 0.55 to 1.45, or 0.55 to 1.40, or 0.55 to 1.35, or 0.55 to 1.30, or 0.55 to 1.25, or 0.55 to 1.2, or 0.55 to 1.15, or 0.55 to 1.1, or 0.55 to 1.05, or 0.55 to 1.0, or 0.55 to 0.95 or 0.55 to 0.9, or 0.6 to 1.5, or 0.6 to 1.45, or 0.6 to 1.40, or 0.6 to 1.35, or 0.6 to 1.30, or 0.6 to 1.25, or 0.6 to 1.2, or 0.6 to 1.15, or 0.6 to 1.1, or 0.6 to 1.05, or 0.6 to 1.0, or 0.6 to 0.95 or 0.6 to 0.9, or 0.65 to 1.5, or 0.65 to 1.45, or 0.65 to 1.40, or 0.65 to 1.35, or 0.65 to 1.30, or 0.65 to 1.25, or 0.65 to 1.2, or 0.65 to 1.15, or 0.65 to 1.1, or 0.65 to 1.05, or 0.65 to 1.0, or 0.65 to 0.95 or 0.65 to 0.9, or 0.7 to 1.5, or 0.7 to 1.45, or 0.7 to 1.40, or 0.7 to 1.35, or 0.7 to 1.30, or 0.7 to 1.25, or 0.7 to 1.2, or 0.7 to 1.15, or 0.7 to 1.1, or 0.7 to 1.05, or 0.7 to 1.0, or 0.7 to 0.95 or 0.7 to 0.9.

In one embodiment or in combination with any other embodiment, class or subclass of this first aspect, wherein the sum of DS_{Pr} and DS_{Ac} is from 1.9 to 2.44, or 1.9 to 2.0, or 1.9 to 2.1, or 1.9 to 2.2, or 1.9 to 2.3, or 2.0 to 2.44, or 2.0 to 2.1, or 2.0 to 2.2, or 2.0 to 2.3, or 2.1 to 2.44, or 2.1 to 2.2, or 2.1 to 2.3, or 2.2 to 2.44, or 2.2 to 2.3.

In one embodiment or in combination with any other embodiment, class or subclass of this first aspect, wherein the MCE exhibits at least 40% biodegradability, at least 45% biodegradability, or at least 50% biodegradability, or at least 55% biodegradability, at least 60% biodegradability, or at least 65% biodegradability, or at least 70% biodegradability, or at least 75% biodegradability, or at least 80% biodegradability, or at least 85% biodegradability, at 56 days according to the OECD 301F test method.

In one embodiment or in combination with any other embodiment, class or subclass of this first aspect, the MCE has a weight average molecular weight in the range of from 5,000 to 100,000 Da, or 5,000 to 50,000 Da, or 5,000 to 25,000 Da, or 15,000 to 100,000 Da, or 15,000 to 50,000 Da, or 15,000 to 25,000 Da, or 50,000 to 100,000 Da, or 75,000 to 100,000 Da, or 15,000 to 250,000 Da.

The present application discloses, in a second aspect, a mixed cellulose ester (“MCE”), comprising: (1) a plurality of acetyl substituents; (2) a plurality of propionyl substituents; and (3) a plurality of hydroxyl substituents, wherein: the MCE has an average degree of substitution for the acetyl substituents (“DS_{Ac}”) is from 0.6 to 1.2, the MCE has an average degree of substitution for the propionyl substituents (“DS_{Pr}”) is from 1.05 to 1.4, and the MCE has an average degree of substitution for the hydroxyl substituents (“DS_{OH}”) is from 0.7 to 1.4.

In one embodiment or in combination with any other embodiment, class or subclass of this second aspect, wherein the DS_{Ac} is from 0.6 to 0.7, or 0.6 to 0.8, or 0.6 to 0.9, or 0.6 to 1.0, or 0.6 to 1.1, or 0.7 to 0.9, or 0.7 to 1.0, or 0.7 to 1.1, or 0.7 to 1.2, or 0.8 to 0.9, or 0.8 to 1.0, or 0.8 to 1.1, or 0.8 to 1.2, or 0.9 to 1.0, or 0.9 to 1.1, or 0.9 to 1.2, or 1.0 to 1.1, or 1.0 to 1.2, or 1.1 to 1.2.

In one embodiment or in combination with any other embodiment, class or subclass of this second aspect, wherein the DS_{Pr} is from 1.05 to 1.35, or 1.05 to 1.3, or 1.05 to 1.25, or 1.05 to 1.2, or 1.05 to 1.15, or 1.05 to 1.1, or 1.1 to 1.4, or 1.1 to 1.35, or 1.1 to 1.3, or 1.1 to 1.25, or 1.1 to 1.2, or 1.1 to 1.15, or 1.15 to 1.4, or 1.15 to 1.35, or 1.15 to 1.3, or 1.15 to 1.25, or 1.15 to 1.2, or 1.2 to 1.4, or 1.2 to 1.35, or 1.2 to 1.3, or 1.2 to 1.25, or 1.25 to 1.4, or 1.25 to 1.35, or 1.25 to 1.3, or 1.3 to 1.4, or 1.3 to 1.35.

In one embodiment or in combination with any other embodiment, class or subclass of this second aspect, wherein the (DS_{OH}) is from 0.7 to 1.35, or 0.7 to 1.3, or 0.7 to 1.25, or 0.7 to 1.2, or 0.7 to 1.15, or 0.7 to 1.1, or 0.7 to 1.05, or 0.7 to 1.0, or 0.7 to 0.95, or 0.7 to 0.9, or 0.7 to 0.85, or 0.7 to 0.8, or 0.7 to 0.75, or 0.75 to 1.4, or 0.75 to 1.35, or 0.75 to 1.3, or 0.75 to 1.25, or 0.75 to 1.2, or 0.75 to 1.15, or 0.75 to 1.1, or 0.75 to 1.05, or 0.75 to 1.0, or 0.75 to 0.95, or 0.8 to 1.4, or 0.8 to 1.35, or 0.8 to 1.3, or 0.8 to 1.25, or 0.8 to 1.2, or 0.8 to 1.15, or 0.8 to 1.1, or 0.8 to 1.05, or 0.85 to 1.4, or 0.85 to 1.35, or 0.85 to 1.3, or 0.85 to 1.25, or 0.85 to 1.2, or 0.85 to 1.15, or 0.85 to 1.1, or 0.85 to 1.05, or 0.9 to 1.4, or 0.9 to 1.35, or 0.9 to 1.3, or 0.9 to 1.25, or 0.9 to 1.2, or 0.9 to 1.15, or 0.9 to 1.1, or 0.9 to 1.05.

In one embodiment or in combination with any other embodiment, class or subclass of this second aspect, wherein the sum of DS_{Pr} and DS_{Ac} is from 1.65 to 2.3, or 1.65 to 2.2, or 1.65 to 2.1, or 1.65 to 2.0, or 1.65 to 1.9, or 1.65 to 1.8, or 1.7 to 2.3, or 1.7 to 2.2, or 1.7 to 2.1, or 1.7 to 2.0, or 1.7 to 1.9, or 1.7 to 1.8, or 1.75 to 2.3, or 1.75 to 2.2, or 1.75 to 2.1, or 1.75 to 2.0, or 1.75 to 1.9, or 1.8 to 2.3, or 1.8 to 2.2, or 1.8 to 2.1, or 1.8 to 2.0, or 1.8 to 1.9, or 1.9 to 2.3, or 1.9 to 2.2, or 1.9 to 2.1, or 1.9 to 2.0, or 2.0 to 2.3, or 2.0 to 2.2, or 2.0 to 2.1.

In one embodiment or in combination with any other embodiment, class or subclass of this second aspect, wherein the (DS_{OH}) is from 0.6 to 0.7, or 0.7 to 1.35, or 0.7 to 1.3, or 0.7 to 1.25, or 0.7 to 1.2, or 0.7 to 1.15, or 0.7 to 1.1, or 0.7 to 1.05, or 0.7 to 1.0, or 0.7 to 0.95, or 0.7 to 0.9, or 0.7 to 0.85, or 0.7 to 0.8, or 0.7 to 0.75, or 0.75 to 1.4, or 0.75 to 1.35, or 0.75 to 1.3, or 0.75 to 1.25, or 0.75 to 1.2, or 0.75 to 1.15, or 0.75 to 1.1, or 0.75 to 1.05, or 0.75 to 1.0, or 0.75 to 0.95, or 0.8 to 1.4, or 0.8 to 1.35, or 0.8 to 1.3, or 0.8 to 1.25, or 0.8 to 1.2, or 0.8 to 1.15, or 0.8 to 1.1, or 0.8 to 1.05, or 0.85 to 1.4, or 0.85 to 1.35, or 0.85 to 1.3, or 0.85 to 1.25, or 0.85 to 1.2, or 0.85 to 1.15, or 0.85 to 1.1, or 0.85 to 1.05, or 0.9 to 1.4, or 0.9 to 1.35, or 0.9 to 1.3, or 0.9 to 1.25, or 0.9 to 1.2, or 0.9 to 1.15, or 0.9 to 1.1, or 0.9 to 1.05.

In one embodiment or in combination with any other embodiment, class or subclass of this second aspect, wherein the MCE exhibits at least 40% biodegradability, at least 45% biodegradability, or at least 50% biodegradability, or at least 55% biodegradability, at least 60% biodegradability, or at least 65% biodegradability, or at least 70% biodegradability, or at least 75% biodegradability, or at least 80% biodegradability, or at least 85% biodegradability, at 56 days according to the OECD 301F test method.

In one embodiment or in combination with any other embodiment, class or subclass of this second aspect, the MCE has a weight average molecular weight in the range of from 5,000 to 100,000 Da, or 5,000 to 50,000 Da, or 5,000 to 25,000 Da, or 15,000 to 100,000 Da, or 15,000 to 50,000 Da, or 15,000 to 25,000 Da, or 50,000 to 100,000 Da, or 75,000 to 100,000 Da, or 15,000 to 250,000 Da.

The present application, in a third aspect, also discloses a mixed cellulose ester (“MCE”), comprising: (1) a plurality of acetyl substituents; (2) a plurality of butyryl substituents; and (3) a plurality of hydroxyl substituents, wherein: the MCE has an average degree of substitution for the acetyl substituents (“DS_{Ac}”) is from 0.9 to 2.4, the MCE has an average degree of substitution for the butyryl substituents (“DS_{Bu}”) is from 0.1 to 1.1, the MCE has an average degree of substitution for the hydroxyl substituents (“DS_{OH}”) is from 0.6 to 1.5.

In one embodiment or in combination with any other embodiment, class or subclass of this third aspect, wherein the DS_{Ac} is from 0.9 to 2.4, 0.9 to 2.3, or 0.9 to 2.2, or 0.9 to 2.1, or 0.9 to 2.0, or 0.9 to 1.9, or 0.9 to 1.8, or 0.9 to 1.7, or 0.9 to 1.6, or 0.9 to 1.4, 0.9 to 1.3, or 0.9 to 1.2, or 0.9 to 1.1, or 0.9 to 1.0, or 0.92 to 2.4, 0.92 to 2.3, or 0.92 to 2.2, or 0.92 to 2.1, or 0.92 to 2.0, or 0.92 to 1.9, or 0.92 to 1.8, or 0.92 to 1.7, or 0.92 to 1.6, or 0.92 to 1.4, 0.92 to 1.3, or 0.92 to 1.2, or 0.92 to 1.1, or 0.92 to 1.0, or 0.94 to 2.4, 0.94 to 2.3, or 0.94 to 2.2, or 0.94 to 2.1, or 0.94 to 2.0, or 0.94 to 1.9, or 0.94 to 1.8, or 0.94 to 1.7, or 0.94 to 1.6, or 0.94 to 1.4, 0.94 to 1.3, or 0.94 to 1.2, or 0.94 to 1.1, or 0.94 to 1.0, or 0.96 to 2.4, 0.96 to 2.3, or 0.96 to 2.2, or 0.96 to 2.1, or 0.96 to 2.0, or 0.96 to 1.9, or 0.96 to 1.8, or 0.96 to 1.7, or 0.96 to 1.6, or 0.96 to 1.4, 0.96 to 1.3, or 0.96 to 1.2, or 0.96 to 1.1, or 0.96 to 1.0, or 0.98 to 2.4, 0.98 to 2.3, or 0.98 to 2.2, or 0.98 to 2.1, or 0.98 to 2.0, or 0.98 to 1.9, or 0.98 to 1.8, or 0.98 to 1.7, or 0.98 to 1.6, 0.98 to 1.4, 0.98 to 1.3, or 0.98 to 1.2, or 0.98 to 1.1, or 0.98 to 1.0, or 1.0 to 2.4, 1.0 to 2.3, or 1.0 to 2.2, or 1.0 to 2.1, or 1.0 to 2.0, or 1.0 to 1.9, or 1.0 to 1.8, or 1.0 to 1.7, or 1.0 to 1.6, or 1.0 to 1.4, or 1.0 to 1.3, 1.0 to 1.2, or 1.0 to 1.1, or 1.1 to 2.4, or 1.1 to 2.3, or 1.1 to 2.2, or 1.1 to 2.1, or 1.1 to 2.0, or 1.1 to 1.9, or 1.1 to 1.8, or 1.1 to 1.7, or 1.1 to 1.6, 1.1 to 1.4, or 1.1 to 1.3, or 1.1 to 1.2, or 1.2 to 2.4, or 1.2 to 2.3, or 1.2 to 2.2, or 1.2 to 2.1, or 1.2 to 2.0, or 1.2 to 1.9, or 1.2 to 1.8, or 1.2 to 1.7, or 1.2 to 1.6, or 1.2 to 1.4, or 1.2 to 1.3, or 1.3 to 2.4, or 1.3 to 2.3, or 1.3 to 2.2, or 1.3 to 2.1, or 1.3 to 2.0, or 1.3 to 1.9, or 1.3 to 1.8, or 1.3 to 1.7, or 1.3 to 1.6, or 1.3 to 1.4, or 1.4 to 2.4, or 1.4 to 2.3, or 1.4 to 2.2, or 1.4 to 2.1, or 1.4 to 2.0, or 1.4 to 1.9, or 1.4 to 1.8, or 1.4 to 1.7, or 1.4 to 1.6, or 1.5 to 2.4, or 1.5 to 2.3, or 1.5 to 2.2, or 1.5 to 2.1, or 1.5 to 2.0, or 1.5 to 1.9, or 1.5 to 1.8, or 1.5 to 1.7, or 1.5 to 1.6, or 1.6 to 2.4, or 1.6 to 2.3, or 1.6 to 2.2, or 1.6 to 2.1, or 1.6 to 2.0, or 1.6 to 1.9, or 1.6 to 1.8, or 1.6 to 1.7, or 1.7 to 2.4, or 1.7 to 2.3, or 1.7 to 2.2, or 1.7 to 2.1, or 1.7 to 2.0, or 1.7 to 1.9, or 1.7 to 1.8, or 1.8 to 2.3, or 1.8 to 2.1, or 1.8 to 2.0, or 1.8 to 1.9, or 1.9 to 2.3, or 1.9 to 2.2, or 1.9 to 2.1, or 1.9 to 2.0, or 2.0 to 2.4, or 2.0 to 2.3, or 2.0 to 2.2, or 2.0 to 2.1, or 2.1 to 2.4, or 2.1 to 2.3, or 2.1 to 2.2, or 2.2 to 2.3.

In one embodiment or in combination with any other embodiment, class or subclass of this third aspect, wherein the DS_{Bu} is from 0.1 to 1.35, or 0.1 to 1.3, or 0.1 to 1.25, or 0.1 to 1.2, or 0.1 to 1.15, or 0.1 to 1.1, or 0.1 to 1.0, or 0.1 to 0.8, or 0.1 to 0.6, or 0.2 to 1.35, or 0.2 to 1.3, or 0.2 to 1.25, or 0.2 to 1.2, or 0.2 to 1.15, or 0.2 to 1.1, or 0.2 to 1.0, or 0.2 to 0.8, or 0.2 to 0.6, or 0.2 to 0.4, or 0.3 to 1.35, or 0.3 to 1.3, or 0.3 to 1.25, or 0.3 to 1.2, or 0.3 to 1.15, or 0.3 to 1.1, or 0.3 to 1.0, or 0.3 to 0.8, or 0.3 to 0.6, or 0.3 to 0.5, or 0.4 to 1.35, or 0.4 to 1.3, or 0.4 to 1.25, or 0.4 to 1.2, or 0.4 to 1.15, or 0.4 to 1.1, or 0.4 to 1.0, or 0.4 to 0.8, or 0.4 to 0.6, or 0.5 to 1.35, or 0.5 to 1.3, or 0.5 to 1.25, or 0.5 to 1.2, or 0.5 to 1.15, or 0.5 to 1.1, or 0.5 to 1.0, or 0.5 to 0.8, or 0.5 to 0.7, or 0.6 to 1.35, or 0.6 to 1.3, or 0.6 to 1.25, or 0.6 to 1.2, or 0.6 to 1.15, or 0.6 to 1.1, or 0.6 to 1.0, or 0.6 to 0.8, or 0.7 to 1.35, or 0.7 to 1.3, or 0.7 to 1.25, or 0.7 to 1.2, or 0.7 to 1.15, or 0.7 to 1.1, or 0.7 to 1.0, or 0.8 to 1.35, or 0.8 to 1.3, or 0.8 to 1.25, or 0.8 to 1.2, or 0.8 to 1.15, or 0.8 to 1.1, or 0.8 to 1.0, or 0.9 to 1.35, or 0.9 to 1.3, or 0.9 to 1.25, or 0.9 to 1.2, or 0.9 to 1.15, or 0.9 to 1.1, or 1.0 to 1.35, or 1.0 to 1.3, or 1.0 to 1.25, or 1.0 to 1.2, or 1.0 to 1.15, or 1.0 to 1.1, or 1.05 to 1.35, or 1.05 to 1.3, or 1.05 to 1.25, or 1.05 to 1.2, or 1.05 to 1.15, or 1.05 to 1.1, or 1.1 to 1.4, or 1.1 to 1.35, or 1.1 to 1.3, or 1.1 to 1.25, or 1.1 to 1.2, or 1.1 to 1.15, or 1.15 to 1.4, or 1.15 to 1.35, or 1.15 to 1.3, or 1.15 to 1.25, or 1.15 to 1.2, or 1.2 to 1.4, or 1.2 to 1.35, or 1.2 to 1.3, or 1.2 to 1.25, or 1.25 to 1.4, or 1.25 to 1.35, or 1.25 to 1.3, or 1.3 to 1.4, or 1.3 to 1.35.

In one embodiment or in combination with any other embodiment, class or subclass of this third aspect, wherein the (DS_{OH}) is from 0.5 to 1.0, or 0.5 to 0.95, or 0.5 to 0.9, or 0.5 to 0.85, or 0.5 to 0.8, or 0.5 to 0.75, or 0.5 to 0.7, or 0.5 to 0.65, or 0.5 to 0.6, or 0.5 to 0.55, or 0.55 to 1.0, or 0.55 to 0.95, or 0.55 to 0.9, or 0.55 to 0.85, or 0.55 to 0.8, or 0.55 to 0.75, or 0.55 to 0.7, or 0.55 or 0.65, or 0.55 to 0.6, or 0.6 to 0.65, or 0.6 to 0.7, or 0.6 to 0.75, or 0.6 to 0.8, or 0.6 to 0.85, or 0.6 to 0.9, or 0.6 to 0.95, or 0.6 to 1.0, or 0.65 to 0.7, or 0.65 to 0.75, or 0.65 to 0.8, or 0.65 to 0.85, or 0.65 to 0.9, or 0.65 to 0.95, or 0.65 to 1.0.

In one embodiment or in combination with any other embodiment, class or subclass of this third aspect, wherein the sum of DS_{Bu} and DS_{Ac} is from 1.65 to 2.3, or 1.65 to 2.2, or 1.65 to 2.1, or 1.65 to 2.0, or 1.65 to 1.9, or 1.65 to 1.8, or 1.7 to 2.3, or 1.7 to 2.2, or 1.7 to 2.1, or 1.7 to 2.0, or 1.7 to 1.9, or 1.7 to 1.8, or 1.75 to 2.3, or 1.75 to 2.2, or 1.75 to 2.1, or 1.75 to 2.0, or 1.75 to 1.9, or 1.8 to 2.3, or 1.8 to 2.2, or 1.8 to 2.1, or 1.8 to 2.0, or 1.8 to 1.9, or 1.9 to 2.3, or 1.9 to 2.2, or 1.9 to 2.1, or 1.9 to 2.0, 2.0 to 2.4, or 2.0 to 2.3, or 2.0 to 2.2, or 2.0 to 2.1.

In one embodiment or in combination with any other embodiment, class or subclass of this third aspect, wherein the MCE exhibits at least 40% biodegradability, at least 45% biodegradability, or at least 50% biodegradability, or at least 55% biodegradability, at least 60% biodegradability, or at least 65% biodegradability, or at least 70% biodegradability, or at least 75% biodegradability, or at least 80% biodegradability, or at least 85% biodegradability, at 56 days according to the OECD 301F test method.

In one embodiment or in combination with any other embodiment, class or subclass of this third aspect, the MCE has a weight average molecular weight in the range of from 5,000 to 100,000 Da, or 5,000 to 50,000 Da, or 5,000 to 25,000 Da, or 15,000 to 100,000 Da, or 15,000 to 50,000 Da, or 15,000 to 25,000 Da, or 50,000 to 100,000 Da, or 75,000 to 100,000 Da, or 15,000 to 250,000 Da.

The present application also discloses, in a fourth aspect, a composition comprising any of the previously disclosed mixed cellulose esters.

In one embodiment or in combination with any other embodiment, class or subclass of this fourth aspect, wherein the composition further comprises a plasticizer. The plasticizer reduces the melt temperature, the Tg, and/or the melt viscosity of the MCE.

In one class of this embodiment or in combination with any other embodiment, class or subclass of this fourth aspect, the plasticizer is triacetin, triethyl citrate, poly(ethylene glycol), Benzoflex, propylene glycol, polysorbatemsucrose octaacetate, acetylated triethyl citrate, acetyl tributyl citrate, Admex, tripropionin, Scandiflex, poloxamer copolymers, polyethylene glycol succinate, diisobutyl adipate, polyvinyl pyrollidone, and glycol tribenzoate.

In one class of this embodiment or in combination with any other embodiment, class or subclass of this fourth aspect, the plasticizer is present in an amount of from 1 to 40 wt %, or 1 to 30 wt %, or 1 to 20 wt %, or 1 to 10 wt %, or 1 to 5 wt %, or 5 to 40 wt %, or 5 to 30 wt %, or 5 to 20 wt %, or 5 to 10 wt %, or 5 to 5 wt %, or 10 to 40 wt %, or 10 to 30 wt %, or 10 to 20 wt %, or 10 to 10 wt %, or 10 to 5 wt %, 15 to 40 wt %, or 15 to 30 wt %, or 15 to 20 wt %, or 15 to 10 wt %, or 15 to 5 wt %, based on the weight of the cellulose ester composition.

In one class of this embodiment, the plasticizer is a biodegradable plasticizer. Some examples of biodegradable plasticizers include triacetin, triethyl citrate, acetyl triethyl citrate, polyethylene glycol, the benzoate-containing plasticizers such as the Benzoflex™ plasticizer series, poly(alkyl succinates) such as poly(butylene succinate), polyethersulfones, adipate-based plasticizers, soybean oil epoxides such as the Paraplex™ plasticizer series, sucrose-based plasticizers, dibutyl sebacate, tributyrin, sucrose acetate isobutyrate, the Resolflex™ series of plasticizers, triphenyl phosphate, glycolates, poly(ethylene glycol), 2,2,4-trimethylpentane-1,3-diyl bis(2-methylpropanoate), and polycaprolactones.

In one embodiment or in combination with any other embodiment, class or subclass of this fourth aspect, the composition further comprises at least one biodegradable polymer that is different than the MCE.

In one class of this embodiment or in combination with any other embodiment of this fourth aspect, class or subclass, the biodegradable polymer is chosen from polyhydroxyalkanoates (PHAs and PHBs), poly(lactic acid) (PLA), polycaprolactone polymers (PCL), poly(butylene adipate co-terephthalate) (PBAT), poly(ethylene succinate) (PES), poly(vinyl acetates) (PVAs), poly(butylene succinate) (PBS) and copolymers [such as poly(butylene succinate-co-adipate) (PBSA)], other cellulose esters, cellulose ethers, starch, proteins, derivatives thereof, and combinations thereof.

In one class of this embodiment or in combination with any other embodiment, class or subclass of this fourth aspect, the composition comprises two or more biodegradable polymers.

In one class of this embodiment or in combination with any other embodiment, class or subclass of this fourth aspect, the composition comprises a biodegradable polymer in an amount from 0.1 to 60 wt %, 0.1 to 50 wt %, or 0.1 to 40 wt %, or 0.1 to 30 wt %, or 0.1 to 20 wt %, or 0.1 to 15 wt %, or 0.1 to 10 wt %, or 0.1 to 5 wt %, or 1 to 40 wt %, or 1 to 30 wt %, or 1 to 25 wt %, or 1 to 20 wt %, or 1 to 10 wt %, or 1 to 5 wt %, or 5 to 40 wt %, or 5 to 30 wt %, or 5 to 25 wt %, or 5 to 20 wt %, or 5 to 10 wt %, based on the total weight of the composition.

In one embodiment or in combination with any other embodiment, class or subclass of this fourth aspect, wherein the composition further comprises at least one of a filler, an additive, a stabilizer, and/or odor modifier.

In one class of this embodiment or in combination with any other embodiment, class or subclass of this fourth aspect, the filler is of a type and present in an amount to enhance biodegradability and/or compostability.

In one class of this embodiment or in combination with any other embodiment, class or subclass of this fourth aspect, the composition comprises at least one filler chosen from: carbohydrates (sugars and salts), cellulosic and organic fillers (wood flour, wood fibers, hemp, carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes or byproduct (eggshells, distillers grain, and coffee grounds), desiccants (e.g. calcium sulfate, magnesium sulfate, magnesium oxide, calcium oxide), alkaline fillers (e.g., Na₂CO₃, MgCO₃), or combinations (e.g., mixtures) of these fillers.

In one class of this embodiment or in combination with any other embodiment, class or subclass of this fourth aspect, the composition can include at least one filler that also functions as a colorant additive. In one subclass of this class or in combination with any other embodiment, class or subclass of this fourth aspect, the colorant additive filler can be chosen from: carbon, graphite, titanium dioxide, opacifiers, dyes, pigments, toners and combinations thereof.

In one class of this embodiment or in combination with any other embodiment, class or subclass of this fourth aspect, the composition can include at least one filler that also functions as a stabilizer or flame retardant.

In one class of this embodiment or in combination with any other embodiment, class or subclass of this fourth aspect, the composition further comprises at least one filler in an amount from 1 to 60 wt %, or 5 to 55 wt %, or 5 to 50 wt %, or 5 to 45 wt %, or 5 to 40 wt %, or 5 to 35 wt %, or 5 to 30 wt %, or 5 to 25 wt %, or 10 to 55 wt %, or 10 to 50 wt %, or 10 to 45 wt %, or 10 to 40 wt %, or 10 to 35 wt %, or 10 to 30 wt %, or 10 to 25 wt %, or 15 to 55 wt %, or 15 to 50 wt %, or 15 to 45 wt %, or 15 to 40 wt %, or 15 to 35 wt %, or 15 to 30 wt %, or 15 to 25 wt %, or 20 to 55 wt %, or 20 to 50 wt %, or 20 to 45 wt %, or 20 to 40 wt %, or 20 to 35 wt %, or 20 to 30 wt %, all based on the total weight of the composition.

In one class of this embodiment or in combination with any other embodiment, class or subclass of this fourth aspect, the stabilizer is at least one of a UV absorber, an antioxidant (e.g., ascorbic acid, BHT, BHA, etc), acid or radical scavengers, epoxidized oils (e.g., epoxidized soybean oil), or combinations thereof.

In one class of this embodiment or in combination with any other embodiment, class or subclass of this fourth aspect, the stabilizer comprises one or more secondary antioxidants.

In one class of this embodiment or in combination with any other embodiment, class or subclass of this fourth aspect, the stabilizer comprises a first stabilizer component chosen from one or more secondary antioxidants and a second stabilizer component chosen from one or more primary antioxidants, citric acid or a combination thereof.

In one class of this embodiment or in combination with any other embodiment, class or subclass of this fourth aspect, the additive is an organic acid, a salt, a wax, a compatibilizer, a biodegradation promoter, a dye, a pigment, a colorant, a luster control agent, a lubricant, an antioxidant, a viscosity modifier, an antifungal agent, an anti-fogging agent, an impact modifier, an antibacterial agent, a softening agent, a mold release agent, or combinations thereof. It should be noted that the same type of compounds or materials can be identified for or included in multiple categories of components in the compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

Antioxidants can be classified into several classes, including primary antioxidant, and secondary antioxidant. Primary antioxidants a generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL, HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often called hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In one subclass of this class or in combination with any other embodiment, class or subclass of this fourth aspect, the odor modifier can be chosen from: vanillin, Pennyroyal M-1178, almond, cinnamyl, spices, spice extracts, volatile organic compounds or small molecules, and Plastidor. In one subclass of this class or in combination with any other embodiment, class or subclass of this fourth aspect, the odor modifier is vanillin.

In one subclass of this class or in combination with any other embodiment, class or subclass of this fourth aspect, the odor modifier is present in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives can include masking, capturing, complementing or combinations of these.

In one subclass of this class or in combination with any other embodiment, class or subclass of this fourth aspect, the compatibilizer is a non-reactive compatibilizer or a reactive compatibilizer. The compatibilizer can enhance the ability of the MCE or another component to reach a desired small particle size to improve the dispersion of the chosen component in the composition.

In one subclass of this class or in combination with any other embodiment, class or subclass of this fourth aspect, the compatibilizer is present in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the composition.

In one subclass of this class or in combination with any other embodiment, class or subclass of this fourth aspect, the salt is an alkaline earth metal oxide, an alkaline earth metal hydroxide, an alkaline earth metal carbonate, an alkali metal carbonate, an alkali metal bicarbonate, ZnO, and basic Al₂O₃. In one subclass of this class or in combination with any other embodiment, class or subclass of this fourth aspect, the salt is MgO, Mg(OH)₂, MgCO₃, CaO, Ca(OH)₂, CaCO₃, NaHCO₃, Na₂CO₃, K₂CO₃, ZnO KHCO₃ or basic Al₂O₃.

In one subclass of this class or in combination with any other embodiment, class or subclass of this fourth aspect, the organic acid is acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

In one subclass of this class or in combination with any other embodiment, class or subclass of this fourth aspect, the biodegradation promoter may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-hydroxy esters), polycarbonates, polyanhydrides, polyacetals, polycaprolactones, poly(orthoesters), polyamino acids, aliphatic polyesters such as poly(butylene) succinate, poly(ethylene) succinate, starch, regenerated cellulose, or aliphatic-aromatic polyesters such as PBAT.

In one subclass of this class or in combination with any other embodiment, class or subclass of this fourth aspect, the colorant can include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide, and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In one subclass of this class or in combination with any other embodiment, class or subclass of this fourth aspect, the luster control agent can include silica, talc, clay, barium sulfate, barium carbonate, calcium sulfate, calcium carbonate, magnesium carbonate, and the like.

In one subclass of this class or in combination with any other embodiment, class or subclass of this fourth aspect, the antifungal and/or antibacterial agents include polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

In one subclass of this class or in combination with any other embodiment, class or subclass of this fourth aspect, viscosity modifiers having the purpose of modifying the melt flow index or viscosity of the composition that can be used include polyethylene glycols and polypropylene glycols, and glycerin.

In one subclass of this class or in combination with any other embodiment, class or subclass of this fourth aspect, the mold release agent or lubricant (e.g. fatty acids, ethylene glycol distearate), anti-block or slip agents (e.g. fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers.

### Disintegration Vs Biodegradation

In general, degradation is followed by the determination of parameters such as DOC (dissolved organic carbon), CO₂ production and oxygen uptake. There are three main methods for testing the biodegradation of a material: the Sturm method, respirometry method, and the radio-labeled ¹⁴C atom test method. The Sturm method precisely measures carbon dioxide production through a change in pressure. The respirometry test precisely measures the oxygen consumption over 60 days. Finally, the radio-labeled ¹⁴C atom test determines ¹⁴C conversion to ¹⁴CO₂. All three methods can be used under aquatic or composting conditions if the right equipment is used.

Freshwater Modified Sturm Test (OECD 301B) The amount of carbon dioxide (CO₂) produced as a percentage of theoretical yield (based on total organic carbon analysis) is used as a basis for assessing whether the material biodegrades. CO₂ is measured by way of a sodium hydroxide trap. The study is run for a minimum of 28 days and may be continued if the yield of CO₂ is showing signs of increase towards the end of the 28-day period.

Biodegradation Test—O₂ Consumption (OECD 301F) may be used to monitor biodegradation of polymeric materials. OECD 301F is an aquatic aerobic biodegradation test that determines the biodegradability of a material by measuring oxygen consumption. OECD 301F is most often used for insoluble and volatile materials that are challenged by OECD 301B testing. The purity or proportions of major components of the test material is important for calculating the Theoretical Oxygen Demand (ThOD). Like other OECD 301 test methods, the standard test duration for OECD 301F is a minimum of 28 days and can measure ready or inherent biodegradability. A solution or suspension, of the test substance in a mineral medium is inoculated and incubated under aerobic conditions in the dark or in diffuse light. A reference compound (typically sodium acetate or sodium benzoate) is run in parallel to check the operation of the procedures.

There are three classifications of biodegradability: readily biodegradable, inherently biodegradable, and not biodegradable. A material is readily biodegradable if it reaches ≥60% of its theoretical oxygen demand within 28 days. Inherently biodegradable materials also reach the 60% level, but only after the 28-day window has passed. Normally, the test for materials that are readily biodegradable lasts for 28 days, while a prolonged test period may be used to classify materials as inherently biodegradable.

The OxiTop method is a modified Sturm method to analyze biodegradation while reporting biodegradability as oxygen consumption, converting the pressure from the CO₂ produced during the test to BOD, biological oxygen demand. OxiTop provides precise measurement in an easy to use format for aquatic biodegradation. Biological Oxygen Demand [BOD] was measured over time using an OxiTop® Control OC 110 Respirometer system. This is accomplished by measuring the negative pressure that develops when oxygen is consumed in the closed bottle system. NaOH tablets are added to the system to collect the CO₂ given off when O₂ is consumed. The CO₂ and NaOH react to form Na₂CO₃, which pulls CO₂ out of the gas phase and causes a measurable negative pressure. The OxiTop measuring heads record this negative pressure value and relay the information wirelessly to a controller, which converts CO₂ produced into BOD due to the 1:1 ratio. The measured biological oxygen demand can be compared to the theoretical oxygen demand of each test material to determine the percentage of biodegradation. The OxiTop can be used to screen materials for ready or inherent biodegradability.

The present application also discloses, of a fifth aspect, an article comprising any one of the previously disclosed mixed cellulose esters.

The present application also discloses, of a sixth aspect, a bead comprising any one of the previously disclosed mixed cellulose esters.

In one embodiment or in combination with any other embodiment, class or subclass of this sixth aspect, the bead has a diameter of from 0.5 to 100 microns, or 0.5 to 50 microns, or 0.5 to 40 microns, or 0.5 to 30 microns, or 0.5 to 20 microns, or 0.5 to 10 microns, or 1 to 100 microns, or 1 to 70 microns, or 1 to 60 microns, or 1 to 50 microns, 1 to 52 microns, or 1 to 40 microns, or 1 to 30 microns, or 1 to 20 microns, or 1 to 10 microns.

In one embodiment or in combination with any other embodiment, class or subclass of this sixth aspect, the bead exhibits a sphericity of from 50 to 100%, or 60 to 100%, or 70 to 100%, or 80 to 100%, or 90 to 100%, or 50 to 90%, or 50 to 80%, or 50 to 70%, or 60 to 90%, or 60 to 80%, or 60 to 70%, or 70 to 90%, or 70 to 80%, or 80 to 90%, or at least 70%, or at least 80%, or at least 90%. The sphericity can be determined according to the procedure disclosed in U.S. Pat. Pub. No. 2020/0299488.

In one embodiment or in combination with any other embodiment, class or subclass of this sixth aspect, the bead exhibits an oil absorption of at least 30 mL per 100 g or 35 mL per 100 g, or 40 mL per 100 g, or 45 mL per 100 g, or 50 mL per 100 g, or 55 mL per 100 g, or 60 mL per 100 g as measured using test method ASTM D281, wherein mineral oil is used instead of castor oil.

In one embodiment or in combination with any other embodiment, class or subclass of this sixth aspect, the bead further comprises a cellulose acetate, wherein the cellulose acetate has an average degree of substitution for the acetyl substituents (“DS_{Ac}”) of from 1.5 to 2.6. In one class of this embodiment, the DS_{Ac} is from 1.8 to 2.2, or 1.5 to 2.0, or 1.8 to 2.0, or 2.0 to 2.2.

The present application also discloses, of a seventh aspect, a composition comprising a plurality of the bead previously disclosed herein.

In one embodiment or in combination with any other embodiment, class or subclass of this seventh aspect, the bead exhibits an oil absorption of at least 30 mL per 100 g or 35 mL per 100 g, or 40 mL per 100 g, or 45 mL per 100 g, or 50 mL per 100 g, or 55 mL per 100 g, or 60 mL per 100 g as measured using test method ASTM D281, wherein mineral oil is used instead of castor oil.

The present application also discloses, of an eighth aspect, a film comprising any one of the previously disclosed mixed cellulose esters.

Films with the desirable optical properties can be used as compensation films. A quarter waveplate is a film wherein the in-plane retardation (“Rₑ”) is equal to a quarter of the light wavelength used to measure the in-plane retardation.

In one embodiment or in combination with any other embodiment, the film is a reverse dispersion quarter waveplate.

The film can be formed by solvent casting, melt extrusion, lamination, or coating processes. These procedures are generally known in the art. Examples of solvent casting, melt extrusion, lamination, and coating methods can be found, for example, in U.S. Patent Application Publication Nos. US 2009/0050842, US 2009/0054638, and US 2009/0096962, the contents of which are incorporated herein by reference. Further examples of solvent casting, melt extrusion, lamination, and coating methods to form films can be found, for example, in U.S. Pat. Nos. 4,592,885 and 7,172,713, and U.S. Patent Application Publication Nos. US 2005/0133953 and US 2010/0055356, the contents of which are incorporated herein by reference.

In one embodiment or in combination with any other embodiment, the film exhibits: (i) an Rₑ(550 nm) that is in the range of 125 nm to 145 nm, (ii) an Rₜₕ(550 nm) that is in the range of −65 nm to −100 nm, (iii) an Rₑ(450 nm)/Rₑ(550 nm) that is in the range of from 0.85 to 0.98, (iv) an Rₑ(650 nm)/Rₑ(550 nm) that is in the range of from 1.07 to 0.96, (v) a film thickness (“d”) of from 35 microns to 80 microns, and (vi) a percent haze of less than 1%, wherein Rₑ(450 nm), Rₑ(550 nm), and Rₑ(650 nm) are in-plane retardations measured with light wavelengths of 450 nm, 550 nm, and 650 nm, respectively, and Rₜₕ(550 nm) is the out of plane retardation measured with a light wavelength of 550 nm.

In one embodiment or in combination with any other embodiment, the film is uniaxially, biaxially, or 45 degree stretched.

In one embodiment or in combination with any other embodiment, the film is biaxially or 45 degree stretched at a ratio of from 0.7 to 1 in the machine direction (“MD”) and 1 to 2 in the transverse direction (“TD”).

In one embodiment or in combination with any other embodiment, the film further comprises 5 to 25 wt % of a plasticizer comprising an aromatic moiety. In one class of this embodiment, the plasticizer is a di((C₁₋₁₀)alkyl) phthalate or triphenyl phosphate.

In one embodiment or in combination with any other embodiment, the film is a reverse dispersion quarter waveplate, comprising: (A) a mixed cellulose ester (“MCE”), comprising: (1) a plurality of acetyl substituents; (2) a plurality of butyryl substituents; and (3) a plurality of hydroxyl substituents, wherein: the MCE has an average degree of substitution for the acetyl substituents (“DS_{Ac}”) that is from 2.05 to 2.2, the MCE has an average degree of substitution for the butyryl substituents (“DS_{Bu}”) that is from 0.18 to 0.25, the MCE has an average degree of substitution for the hydroxyl substituents (“DS_{OH}”) that is from 0.54 to 0.6; and (B) 5-25 wt % of a plasticizer which is a di((C₁₋₁₀)alkyl) phthalate, or diphenyl phosphate, wherein the film exhibits: (i) an Rₑ(550 nm) that is in the range of 125 nm to 145 nm, (ii) an Rₜₕ(550 nm) that is in the range of −65 nm to −100 nm, (iii) an Rₑ(450 nm)/Rₑ(550 nm) that is in the range of from 0.85 to 0.98, (iv) an Rₑ(650 nm)/Rₑ(550 nm) that is in the range of from 1.07 to 0.96, (v) a film thickness (“d”) of from 35 microns to 80 microns, and (vi) a percent haze of less than 1%, wherein Rₑ(450 nm), Rₑ(550 nm), and Rₑ(650 nm) are in-plane retardations measured with light wavelengths of 450 nm, 550 nm, and 650 nm, respectively, and Rₜₕ(550 nm) is the out of plane retardation measured with a light wavelength of 550 nm.

In one class of this embodiment, the film is biaxially or 45 degree stretched at a ratio of from 0.7 to 1 in the machine direction (“MD”) and 1 to 2 in the transverse direction (“TD”).

The present application also discloses, of a ninth aspect, a film prepared from any one of the previously disclosed compositions or mixed cellulose esters.

In one embodiment or in combination with any other embodiment, class or subclass of this ninth aspect, wherein the composition further comprises 1 to 40 wt % of a cellulose acetate, wherein the cellulose acetate exhibits an average degree of substitution for the acetyl substituents of from 1.5 to 2.6. In one class of this embodiment, the DS_{Ac} is from 1.8 to 2.2, or 1.5 to 2.0, or 1.8 to 2.0, or 2.0 to 2.2.

The present application also discloses, of a tenth aspect, cellulose ester particles formed from a cellulose ester composition comprising: (I) a mixed cellulose ester (“MCE”) comprising: (1) a plurality of acetyl substituents; (2) a plurality of (C₂₋₃)alkyl-CO— substituents; and (3) a plurality of hydroxyl substituents, wherein: the MCE has an average degree of substitution for the acetyl substituents (“DS_{Ac}”) that is from 0.6 to 2.4, the MCE has an average degree of substitution for the (C₂₋₃)alkyl-CO— substituents (“DS_{AkCO}”) that is from 0.1 to 1.1, the MCE has an average degree of substitution for the hydroxyl substituents (“DS_{OH}”) that is from 0.55 to 1.5; and (II) a cellulose acetate (“CA”), comprising: a plurality of acetyl substituents; and a plurality of hydroxyl substituents, wherein: the CA has an average degree of substitution for the acetyl substituents (“DS_{Ac}”) that is from 1.5 to 2.6, the CA has an average degree of substitution for the hydroxyl substituents (“DS_{OH}”) that is from 0.4 to 1.5.

In one embodiment or in combination with any other embodiment, class or subclass of this tenth aspect, the (C₂₋₃)alkyl-CO— is propionyl. In one embodiment or in combination with any other embodiment, class or subclass of this tenth aspect, the (C₂₋₃)alkyl-CO— is butyryl.

In one embodiment or in combination with any other embodiment, class or subclass of this tenth aspect, the MCE is present at from 60 wt % to 99 wt %, and the CA is present at from 1 wt % to 40 wt %, based on the total weight of the cellulose ester composition. In one embodiment or in combination with any other embodiment, class or subclass of this tenth aspect, the MCE is present at from 55 wt % to 99 wt %, and the CA is present at from 1 wt % to 45 wt %, based on the total weight of the cellulose ester composition. In one embodiment or in combination with any other embodiment, class or subclass of this tenth aspect, the MCE is present at from 65 wt % to 99 wt %, and the CA is present at from 1 wt % to 35 wt %, based on the total weight of the cellulose ester composition. In one embodiment or in combination with any other embodiment, class or subclass of this tenth aspect, the MCE is present at from 70 wt % to 99 wt %, and the CA is present at from 1 wt % to 30 wt %, based on the total weight of the cellulose ester composition. In one embodiment or in combination with any other embodiment, class or subclass of this tenth aspect, the MCE is present at from 75 wt % to 99 wt %, and the CA is present at from 1 wt % to 25 wt %, based on the total weight of the cellulose ester composition. In one embodiment or in combination with any other embodiment, class or subclass of this tenth aspect, the MCE is present at from 80 wt % to 99 wt %, and the CA is present at from 1 wt % to 20 wt %, based on the total weight of the cellulose ester composition. In one embodiment or in combination with any other embodiment, class or subclass of this tenth aspect, the MCE is present at from 85 wt % to 99 wt %, and the CA is present at from 1 wt % to 25 wt %, based on the total weight of the cellulose ester composition.

In one embodiment or in combination with any other embodiment, class or subclass of this tenth aspect, the cellulose ester particles exhibit at least one of the following: (i) an average particle size of from 1 micron to 60 microns, (ii) a bulk density of from 0.2 to 0.7, (iii) an average surface area of 0.1 m²/g to 10 m²/g, or (iv) a sphericity of from 70% to 100%.

The present application also discloses, of an eleventh aspect, a dope composition comprising: (A) a cellulose ester composition: (I) a mixed cellulose ester (“MCE”) comprising: (1) a plurality of acetyl substituents; (2) a plurality of (C₂₋₃)alkyl-CO— substituents; and (3) a plurality of hydroxyl substituents, wherein: the MCE has an average degree of substitution for the acetyl substituents (“DS_{Ac}”) that is from 0.6 to 2.4, the MCE has an average degree of substitution for the (C₂₋₃)alkyl-CO— substituents (“DS_{AkCO}”) that is from 0.1 to 1.1, the MCE has an average degree of substitution for the hydroxyl substituents (“DS_{OH}”) that is from 0.55 to 1.5, and (II) a cellulose acetate (“CA”), comprising: a plurality of acetyl substituents; and a plurality of hydroxyl substituents, wherein: the CA has an average degree of substitution for the acetyl substituents (“DS_{Ac}”) that is from 1.5 to 2.6, the CA has an average degree of substitution for the hydroxyl substituents (“DS_{OH}”) that is from 0.4 to 1.5; and (B) a solvent, wherein the solvent comprises: (1) water, (2) (C₁₋₂)alkyl acetate, and (3) (C₁₋₅)alkanol, wherein the dope composition exhibits a viscosity in the range of from 3000 to 9000 cP.

In one embodiment or in combination with any other embodiment, class or subclass of this eleventh aspect, the (C₂₋₃)alkyl-CO— is propionyl. In one embodiment or in combination with any other embodiment, class or subclass of this eleventh aspect, the (C₂₋₃)alkyl-CO— is butyryl.

In one embodiment or in combination with any other embodiment, class or subclass of this eleventh aspect, the MCE is present at from 60 wt % to 99 wt %, and the CA is present at from 1 wt % to 40 wt %, based on the total weight of the cellulose ester composition. In one embodiment or in combination with any other embodiment, class or subclass of this eleventh aspect, the MCE is present at from 55 wt % to 99 wt %, and the CA is present at from 1 wt % to 45 wt %, based on the total weight of the cellulose ester composition. In one embodiment or in combination with any other embodiment, class or subclass of this eleventh aspect, the MCE is present at from 65 wt % to 99 wt %, and the CA is present at from 1 wt % to 35 wt %, based on the total weight of the cellulose ester composition. In one embodiment or in combination with any other embodiment, class or subclass of this eleventh aspect, the MCE is present at from 70 wt % to 99 wt %, and the CA is present at from 1 wt % to 30 wt %, based on the total weight of the cellulose ester composition. In one embodiment or in combination with any other embodiment, class or subclass of this eleventh aspect, the MCE is present at from 75 wt % to 99 wt %, and the CA is present at from 1 wt % to 25 wt %, based on the total weight of the cellulose ester composition. In one embodiment or in combination with any other embodiment, class or subclass of this eleventh aspect, the MCE is present at from 80 wt % to 99 wt %, and the CA is present at from 1 wt % to 20 wt %, based on the total weight of the cellulose ester composition. In one embodiment or in combination with any other embodiment, class or subclass of this eleventh aspect, the MCE is present at from 85 wt % to 99 wt %, and the CA is present at from 1 wt % to 25 wt %, based on the total weight of the cellulose ester composition.

In one embodiment or in combination with any other embodiment, class or subclass of this eleventh aspect, the cellulose ester composition is present at from 5 wt % to 20 wt %, and the solvent is present at from 80 wt % to 95 wt % based on the total weight of the dope composition. In one embodiment or in combination with any other embodiment, class or subclass of this eleventh aspect, the cellulose ester composition is present at from 5 wt % to 15 wt %, and the solvent is present at from 85 wt % to 95 wt % based on the total weight of the dope composition. In one embodiment or in combination with any other embodiment, class or subclass of this eleventh aspect, the cellulose ester composition is present at from 5 wt % to 10 wt %, and the solvent is present at from 90 wt % to 95 wt % based on the total weight of the dope composition.

The present application also discloses, of a twelfth aspect, is an organic light emitting diode (“OLED”) display comprising any of the previously disclosed films.

### Specific Embodiments

Embodiment 1. A film comprising a mixed cellulose ester (“MCE”), comprising:
(1) a plurality of acetyl substituents;
(2) a plurality of butyryl substituents; and
(3) a plurality of hydroxyl substituents,
wherein:
   the MCE has an average degree of substitution for the acetyl substituents (“DS_{Ac}”) that is from 0.9 to 2.4,
   the MCE has an average degree of substitution for the butyryl substituents (“DS_{Bu}”) that is from 0.1 to 1.1,
   the MCE has an average degree of substitution for the hydroxyl substituents (“DS_{OH}”) that is from 0.55 to 1.5.

Embodiment 2. The film of Embodiment 1, wherein the sum of DS_{Bu} and DS_{Ac} is from 2.0 to 2.4.

Embodiment 3. The film of any one of Embodiments 1-2, wherein the DS_{Bu} is from 0.1 to 0.3.

Embodiment 4. The film of any one of Embodiments 1-3, wherein the DS_{Ac} is from 2.0 to 2.3.

Embodiment 5. The film of any one of Embodiments 1-4, wherein the (DS_{OH}) is from 0.6 to 0.7.

Embodiment 6. The film of any one of Embodiments 1-5, wherein the film is a reverse dispersion quarter waveplate.

Embodiment 7. The film of any one of Embodiments 1-6, wherein the film exhibits:
(i) an Rₑ(550 nm) that is in the range of 125 nm to 145 nm,
(ii) an Rₜₕ(550 nm) that is in the range of −65 nm to −100 nm,
(iii) an Rₑ(450 nm)/Rₑ(550 nm) that is in the range of from 0.85 to 0.98,
(iv) an Rₑ(650 nm)/Rₑ(550 nm) that is in the range of from 1.07 to 0.96,
(v) a film thickness (“d”) of from 35 microns to 80 microns, and
(vi) a percent haze of less than 1%,
wherein Rₑ(450 nm), Rₑ(550 nm), and Rₑ(650 nm) are in-plane retardations measured with light wavelengths of 450 nm, 550 nm, and 650 nm, respectively, and Rₜₕ(550 nm) is the out of plane retardation measured with a light wavelength of 550 nm.

Embodiment 8. The film of any one of Embodiments 1-7, wherein the film is uniaxially, biaxially, or 45 degree stretched.

Embodiment 9. The film of any one of Embodiments 1-8, wherein the film is biaxially or 45 degree stretched at a ratio of from 0.7 to 1 in the machine direction (“MD”) and 1 to 2 in the transverse direction (“TD”).

Embodiment 10. The film of any one of Embodiments 1-9, wherein the film further comprises 5 to 25 wt % of a plasticizer comprising an aromatic moiety.

Embodiment 11. The film of Embodiment 10, wherein the plasticizer is a di((C₁₋₁₀)alkyl) phthalate or triphenyl phosphate.

Embodiment 12. The film of any one of Embodiments 1-11, wherein the film exhibits at least 40% biodegradability at 56 days according to the OECD 301F test method.

Embodiment 13. A reverse dispersion quarter waveplate, comprising:
(A) a mixed cellulose ester (“MCE”), comprising:
   (1) a plurality of acetyl substituents;
   (2) a plurality of butyryl substituents; and
   (3) a plurality of hydroxyl substituents,
   wherein:
      the MCE has an average degree of substitution for the acetyl substituents (“DS_{Ac}”) that is from 2.05 to 2.2,
      the MCE has an average degree of substitution for the butyryl substituents (“DS_{Bu}”) that is from 0.18 to 0.25,
      the MCE has an average degree of substitution for the hydroxyl substituents (“DS_{OH}”) that is from 0.54 to 0.6; and
(B) 5-25 wt % of a plasticizer which is a di((C₁₋₁₀)alkyl) phthalate, or diphenyl phosphate,
wherein the film exhibits:
   (i) an Rₑ(550 nm) that is in the range of 125 nm to 145 nm,
   (ii) an Rₜₕ(550 nm) that is in the range of −65 nm to −100 nm,
   (iii) an Rₑ(450 nm)/Rₑ(550 nm) that is in the range of from 0.85 to 0.98,
   (iv) an Rₑ(650 nm)/Rₑ(550 nm) that is in the range of from 1.07 to 0.96,
   (v) a film thickness (“d”) of from 35 microns to 80 microns, and
   (vi) a percent haze of less than 1%,
   wherein Rₑ(450 nm), Rₑ(550 nm), and Rₑ(650 nm) are in-plane retardations measured with light wavelengths of 450 nm, 550 nm, and 650 nm, respectively, and Rₜₕ(550 nm) is the out of plane retardation measured with a light wavelength of 550 nm.

Embodiment 14. The film of Embodiment 13, wherein the film is biaxially or 45 degree stretched at a ratio of from 0.7 to 1 in the machine direction (“MD”) and 1 to 2 in the transverse direction (“TD”).

Embodiment 15. The film of any one of Embodiments 13-14, wherein the film exhibits at least 40% biodegradability at 56 days according to the OECD 301F test method.

Embodiment 16. An organic light emitting diode (“OLED”) display comprising the film of any one of Embodiments 1-15.

### Experimental Section

### Abbreviations

Ac₂O is acetic anhydride; AcOH is acetic acid; Biodeg is biodegradation; CA-398-3 is Eastman Cellulose Acetate 398-3; CA-398-6 is Eastman Cellulose Acetate 398-6; CA-398-10 is Eastman Cellulose Acetate 398-10; CA-398-30 is Eastman Cellulose Acetate 398-30; CA-394-60LF is Eastman Cellulose Acetate 394-60LF; CE is cellulose ester; CEx is comparative example; ° C. is degrees Celsius; CAB is cellulose acetate butyrate; CA is cellulose acetate; DS is average degree of substitution; Ex is example(s); DS_{Ac} is the average degree of substitution for acetyl; DS_{Bu} is the average degree of substitution for butyryl; (DS_{OH}) is average degree of substitution for hydroxyl; g is gram(s); h is hour(s); kg is kilogram(s); Mg(OAc)₂ is magnesium acetate; min is minute(s); mL is milliliter; M_{w} is weight average molecular weight; OAc is acetate; Pr₂O is propionic anhydride; PrOH is propionic acid; Pz is plasticizer; rt is room temperature; soln is solution; T_{g} is glass transition temperature; TXIB is Eastman TXIB™ formulation additive (trimethyl pentanyl diisobutyrate); VM234 is Eastman Visualize™ Material 234.

### Preparation of Cellulose Acetate Propionate (Ex 1) (DS_{Ac}=1.1, DS_{Pr}=1.12, DS_{OH}=0.78, M_{w}=153777)

Activated cellulose mixture [cellulose (7.1 parts) and PrOH (11.0 parts)] was cooled to 15° C. in a vessel with overhead stirring. Following, a solution of sulfuric acid (0.2 parts), AC₂O (11.3 parts), and Pr₂O (13.3 parts) (acylation solution) cooled to 15° C. was added to the cooled activated cellulose mixture with stirring. The resulting reaction mixture was warmed to 23° C. and stirred at 23° C. for 60 min. Then the reaction mixture was heated to 63° C. over 45 min, at which point a soln of PrOH (32.3 parts) and H₂O (11.3 parts) was added. The mixture was then stirred at 71° C. for 600 min. The mixture is treated with a solution of Mg(OAc)₂·4H₂O (0.45 parts) in AcOH (7.3 parts) and H₂O (5.6 parts) and the mixture was stirred for 30 min and cooled to rt. The mixture was filtered. The cellulose ester was precipitated from the filtrate with water and agitated in a commercial blender, and the cellulose ester was filtered, collected, the solids were washed with running water and dried in a vacuum oven set at 60° C. until dry to give the desired product.

By adapting the procedure for the preparation of cellulose acetate propionate 1, the following cellulose ester in Table 1 were prepared.

TABLE 1
Preparation conditions for Ex 2-5, 7-8, and CEx 5.

| | Activated Cellulose | | | | | Hydrolysis | | Hydrolysis | |
|---|---|---|---|---|---|---|---|---|---|
| | Mixture | | Acylation Solution | | | Soln | | Condtions | |
| | Cellulose | Acid | H₂SO₄ | Ac₂O | Pr₂O | PrOH | H₂O | Time | Temp. |
| Ex | (parts) | (parts) | (parts) | (parts) | (parts) | (parts) | (parts) | (min) | (° C.) |
| 2 | 7.1 | PrOH (11.0) | 0.2 | 11.3 | 13.3 | 32.3 | 11.3 | 900 | 71 |
| 3 | 7.1 | PrOH (11.8) | 0.2 | 3.8 | 22.2 | 32.0 | 11.1 | 900 | 71 |
| 4 | 7.0 | PrOH (8.5) | 0.2 | 17.8 | 5.0 | 32.2 | 11.3 | 600 | 71 |
| | | AcOH (4.6) | | | | | | | |
| 5 | 7.1 | PrOH (11.1) | 0.2 | 10.1 | 14.6 | 32.1 | 11.3 | 1125 | 71 |
| 7 | 38 | PrOH (62) | 1 | 55 | 44 | 74 | 26 | 750 | 71 |
| 8 | 38 | PrOH (62) | 1 | 55 | 44 | 74 | 26 | 800 | 71 |
| CEx 5 | 38 | PrOH (62) | 1 | 20 | 79 | 74 | 26 | 1350 | 71 |

Table 2 provides properties for the cellulose esters prepared above.

TABLE 2
Degrees of substitution and molecular
weight for Ex 2-5, 7-8, and CEx 5.

| Ex | DS_{Ac} | DS_{Pr} | Total DS | DS_{OH} | M_{w} (Da) |
|---|---|---|---|---|---|
| 2 | 0.90 | 1.06 | 1.96 | 1.04 | 102937 |
| 3 | 0.50 | 1.64 | 2.14 | 1.9 | 166383 |
| 4 | 1.79 | 0.45 | 2.24 | 0.76 | 128258 |
| 5 | 0.59 | 1.07 | 1.66 | 1.34 | 45963 |
| 7 | 1.40 | 0.81 | 2.21 | 0.79 | 65400 |
| 8 | 1.18 | 0.78 | 1.96 | 1.04 | 73400 |
| CEx 5 | 0.55 | 1.34 | 1.89 | 1.11 | 46000 |

### Preparation of Cellulose Acetate Butyrate (Ex 6) (DS_{Ac}=2.17, DS_{Bu}=0.21, DS_{OH}=0.62 M_{w}=80,000-105,000)

Activated cellulose mixture [cellulose (5.4 parts) and AcOH (21.5 parts)] with some amount of sulfuric acid was cooled to 32° C. in an agitated reactor. Following, a mixture of Ac₂O (11.3 parts) and Bu₂O (7.3 parts) was added and the mixture cooled to around 9° C. with agitation. Additional sulfuric acid was added to a total of 0.4 parts and the resulting reaction mixture was warmed to 55° C. To this reaction mixture was added a mixture of AcOH (23.3 parts) and H₂O (9.0 parts). The mixture was then stirred at 68° C. for 495 min, but with the addition of a mixture Mg(OAc)₂ (0.26 parts), BuOH (8.7 parts), AcOH (0.06 parts) and H₂O (3.8 parts) after 80 min. After the full length of time, the mixture was fully neutralized with a solution of Mg(OAc)₂ (0.37 parts), BuOH (1.9 parts), AcOH (0.09 parts) and H₂O (6.7 parts). The mixture was then precipitated in water, washed and dried by common methods.

TABLE 3
Preparation conditions for Ex 9-10, and CEx 6-7.

| | Activated Cellulose | | | | | Hydrolysis | | Hydrolysis | |
|---|---|---|---|---|---|---|---|---|---|
| | Mixture | | Acylation Solution | | | Soln | | Condtions | |
| | Cellulose | Acid | H₂SO₄ | Ac₂O | Bu₂O | PrOH | H₂O | Time | Temp. |
| Ex | (parts) | (parts) | (parts) | (parts) | (parts) | (parts) | (parts) | (min) | (° C.) |
| 9 | 22 | 78 | 2 | 60 | 38 | 72 | 28 | 720 | 71 |
| 10 | 22 | 78 | 2 | 60 | 38 | 72 | 28 | 840 | 71 |
| CEx 6 | 37 | 63 | 1 | 39 | 60 | 74 | 26 | 1350 | 71 |
| CEx 7 | 35 | 65 | 1 | 59 | 40 | 74 | 26 | 600 | 71 |

TABLE 4
Degrees of substitution and molecular
weight for Ex 9-10, and CEx 6-7.

| Ex | DS_{Ac} | DS_{Bu} | Total DS | DS_{OH} | M_{w} (Da) |
|---|---|---|---|---|---|
| 9 | 2.01 | 0.23 | 2.24 | 0.76 | 55796 |
| 10 | 1.98 | 0.22 | 2.2 | 0.80 | 71904 |
| CEx 6 | 1.07 | 0.74 | 1.81 | 1.19 | 29900 |
| CEx 7 | 1.75 | 0.65 | 2.40 | 0.60 | 22400 |

### Biodegradation

The biodegradation of CEs was evaluated in an aqueous aerobic biodegradation test according to ISO 14851 or OECD 301F method. The total test duration was around 56 days. The tests were performed at 21° C.±2° C. The biodegradation tests were performed using Eastman wastewater treatment sludge as inoculum.

In this test CEs were dispersed in a chemically defined mineral media free of other organic carbon sources and inoculated with micro-organisms from wastewater sludge. As the microbes biodegraded test materials in the aqueous media oxygen is consumed by the microbes and carbon from the test material is converted into CO₂. Carbon dioxide produced in the process was trapped by NaOH inside the bottle (NaOH placed in the quiver inside the closed test bottles) and that causes pressure drop in the headspace. This pressure drop corresponds directly to oxygen being consumed and hence to the biodegradation of the test material.

The biodegradation is calculated from the Oxygen consumption as ratio of BOD (biological oxygen demand) after correcting for the control to the theoretical oxygen demand of the test item. A material is considered biodegradable if it has reach at least 90% or 90% of the reference material (according to ISO 14851) by 56 days. And according to ECHA microplastic proposal if the material has reached at least 60% biodegradation by 60 days it is considered biodegradable.

TABLE 5
provides the freshwater biodegradation
properties of CEx 1-7 and Ex 1-10.

| | Test | % | Onset of | Initial slope |
|---|---|---|---|---|
| | Duration | Degradation | biodeg. | of biodeg. |
| Ex # | (Days) | at end time | (Days) | (%/Day) |
| CEx 1 | 56 | 83.8-86.0 | 1.4-3.0 | 6.0-8.0 |
| CEx 2 | 36 | 72.1 | 6.0 | 8.7 |
| CEx 3 | 54 | 2.6 | N/A | N/A |
| CEx 4 | 56 | 0.3 | N/A | N/A |
| 1 | 40 | 66.7 | 20.9 | 4.4 |
| 2 | 56 | 67.0 | 16.2 | 5.0 |
| 3 | — | — | — | — |
| 4 | 56 | 80.8 | 5.5 | 11.8 |
| 5 | 56 | 68.0 | 10.7 | 6.6 |
| 6 | 56 | 59.6 | 11.8 | 3.9 |
| 7 | 35 | 66.0 | 17.0 | 4.38 |
| 8 | 26 | 74.6 | 9.6 | 7.52 |
| CEx 5 | 30 | 2.2 | 25.0 | 1.32 |
| 9 | 55 | 67.0 | 14.5 | 3.01 |
| 10 | 55 | 81.8 | 9.6 | 6.32 |
| CEx 6 | 31 | 5.09 | NA | NA |
| CEx 7 | 30 | −1.37 | NA | NA |

### Preparation of Microbeads

### Preparation Procedure 1

Procedure 1 is based on the procedures disclosed in EP0750007 (“EP′007”).

### Cellulose Acetate Butyrate Microbeads 7 (Procedure 1)

Ex 6 (40 g), EtOAc (185 g), and EtOH (25 g) were used for the oil phase; and Benecel A4M (1.5 g), Tween 28 (4.5 g), water (350 g), and EtOAc (50 mL) were used for the aqueous phase. The aqueous phase was premixed using a roto-stator at 9000 rpm for 5 min and then the oil phase was added to the aqueous phase over 20 min. The formed oil emulsion was stirred for 50 min and the emulsion was filtered through a 200 mesh sieve into water (2500 mL) over five min under stirring. The resulting mixture was stirred for 1 h. The formed microparticles were filtered. The resulting microparticles were washed with water and centrifuged at 10,000 for 10 min to separate the particles from the aqueous phase (repeated 3×). The final microparticles exhibited a D10 of 1.21 microns, D50 of 4.96 microns, D90 of 12 microns, and polydispersity of 0.646, which was determined by light scattering. D10, or D50, or D90, are the particle size value below which 10%, or 50%, or 90% of the material is contained.

### Preparation Procedure 2

### Dope

A dope of the cellulose ester mixture was prepared by adding the cellulose ester mixture (90 g) to a ethyl acetate, (C₂₋₃)alkanol, water mixture (547.7 g, 80:13:7) while stirring at 250 rpm. The resulting mixture was stirred at rt (˜30 min).

### Cellulose Acetate Butyrate/Cellulose Acetate Dope Preparations

Table 4 provides the cellulose acetate used to prepare representative dopes with Ex 6. Table 5 shows which cellulose acetate butyrate/cellulose acetate dopes are possible from an ethyl acetate, ethanol, and water solution system. The dopes were prepared by mixing CAB/CA (6.0 g) in a solvent [37.0 g (EA:EtOH:Water, 80:13:7)].

TABLE 6
Description of cellulose acetate materials used
to make mixed ester-cellulose acetate microbeads.

| CA | DS_{Ac} |
|---|---|
| CA-398-3 | 2.4 |
| CA-398-6 | 2.4 |
| CA-398-10 | 2.4 |
| CA-398-30 | 2.4 |
| CA-394-60LF | 2.4 |

Table 7 provides dopes made from either Ex 6, various cellulose acetates, or blends of Ex 6 and various cellulose acetates according to the Dope Procedure in Preparation Procedure 2. Only certain cellulose acetates could be blended with Ex 6 to form dopes in the EA:EtOH:Water solvent system, and none of the cellulose acetates used were able to form dopes in the EA:EtOH:Water solvent system. Ex 6 readily formed a dope in the EA:EtOH:Water solvent system

TABLE 7
Dope preparations of Ex 6 and various CA using
a EA:EtOH:Water (80:13:7) solvent system.

| | | | Viscosity |
|---|---|---|---|
| Ex 6 (wt %) | CA (wt %) | Soluble | (cP) |
| 100 | — | Yes | 5830-9000 |
| — | CA-398-3 (100) | No | — |
| — | CA-398-6 (100) | No | — |
| — | CA-398-10(100) | No | — |
| — | CA-398-30 (100) | No | — |
| — | CA-394-60LF (100) | No | — |
| 90 | CA-398-3 (10) | Yes | 4360 |
| 70 | CA-398-3 (30) | No¹ | — |
| 90 | CA-398-6 (10) | Yes | 5180 |
| 70 | CA-398-6 (30) | Yes-cloudy | 3660 |
| 90 | CA-398-10 (90) | No | — |
| 70 | CA-398-10 (30) | No | — |
| 90 | CA-398-30 (90) | Yes-cloudy | 5020 |
| 70 | CA-398-30 (30) | Yes-Cloudy | 5200 |
| 90 | CA-398-60LF (10) | No | — |
| 70 | CA-398-60LF (30) | No | — |

¹Some level of solids/gels remained after 72 h.

### Aqueous Mixture

The aqueous mixture used to prepare the emulsion is prepared by mixing ethyl acetate (124.6 g) with methyl cellulose (6.8 g) with a 2-stage pitched bladed agitator (250 rpm) until a dispersion is formed. Then water (1280 g) and Tween-28 (13.5 g) is added. The resulting aqueous mixture is agitated for ˜30 min at which time a solution is formed

### Emulsion/Dispersion Method for Forming Bead

The dope (637.7 g) is charged to the aqueous mixture (1424.3 g) at a rate of 15 mL/min (˜45 min) while agitating (250 rpm). Afterwards, the resulting mixture was agitated at 250 rpm and recirculating the mixture through a MagicLab inline high-sheer mixer (6000 rpm) at 200 mL/min for 30 min.

Then the mixture is added to water (5625 g) with agitation (250 rpm) at 200 mL/min, and the mixture was agitated for 2 h at rt. The mixture was centrifuged (3000 rpm, 15 min) to separate the beads. The beads were washed with water and re-centrifuged (3000 rpm, 15 min) (2×). The resulting beads were dried at 100° C. in an oven at 150 mmHg (16 h).

Table 8 provides microbeads made using procedure 2 using a blend of Ex 6 with various weight percentages of several cellulose acetates.

TABLE 8
Process results of microbeads from CA/CAb blends

| | | | Particle | | | | Bulk |
|---|---|---|---|---|---|---|---|
| Ex | | Ex 6 | Size¹, | <1 | Modality | | Den, |
| # | CA (wt %) | (w %) | μm | μm, % | of PSD² | Span³ | g/mL |
| 8 | CA-398-3 | 90 | 8.24 | 1.59 | Bimodal | 2.17 | 0.534 |
| | (10) | | | | | | |
| 9 | CA-398-3 | 80 | 12.7 | 1.42 | Trimodal | 2.74 | 0.541 |
| | (20) | | | | | | |
| 10 | CA-398-3 | 70 | 16.4 | 1.36 | Tetramodal | 2.16 | no data |
| | (30) | | | | | | |
| 11 | CA-398-6 | 90 | 9.48 | 1.72 | Trimodal | 1.82 | 0.541 |
| | (10) | | | | | | |
| 12 | CA-398-6 | 80 | 10.3 | 0.75 | Trimodal | 2.09 | 0.541 |
| | (20) | | | | | | |
| 13 | CA-398-6 | 70 | 7.59 | 1.02 | Bimodal | 1.78 | 0.536 |
| | (30) | | | | | | |
| 14 | CA-398-30 | 90 | 9.64 | 1.57 | Bimodal | 1.92 | 0.491 |
| | (10) | | | | | | |
| 15 | CA-398-30 | 80 | 11.7 | 1.23 | Trimodal | 2.13 | 0.499 |
| | (20) | | | | | | |
| 16 | CA-398-30 | 70 | 15.6 | 1.41 | Trimodal | 2.14 | 0.507 |
| | (30) | | | | | | |

¹Volume-based particle size
²PSD = Particle Size Distribution
³Span = (D₉₀ − D₁₀)/D₅₀

### Oil Take Measurement

The absorption or oil uptake properties were measured using the test method of ASTM D281 “Standard Test Method for Oil Absorption of Pigments by Spatula Rub-out,” instead of castor oil, mineral oil was used. The mineral oil (Item No. ELL-MIOL-01) was obtained from MakingCosmetics.com, Inc.

The mineral oil is added dropwise to a known amount of neat powder and stirred with a spatula until a solid dry paste is formed. When the solid dry paste is formed, no more mineral oil is absorbed. Once the amount of oil is determined, the oil take calculated using the following formula:

$$OT = ( 100 \times {V}_{oil} ) / {m}_{sample}$$

OT: Oil Take (mL/100 g); Vₒᵢₗ: volume of oil used (mL); mₛₐₘₚₗₑ: the mass of the sample (g)
   The results are shown in Table 4.

TABLE 9

| | | | | d_{Mineral} | | |
|---|---|---|---|---|---|---|
| | | m_{Sample} | Mineral | _{Oil} | Vₒᵢₗ | OT |
| Ex | Type | (g) | Oil (g) | (g/mL) | (mL) | (mL/100 g) |
| 7 | CAB | 1.5 | 0.69 | 0.838 | 0.823389 | 55 |
| | (Spherical) | | | | | |

### Preparation of Films

The cellulose mixed esters disclosed herein are useful in the preparation of films such as optical films. Table 10 provides a number of films formed from exemplary cellulose mixed esters.

The films were solvent cast from a 12 wt % solids dope of the cellulose mixed ester, plasticizer and solvent (methylene chloride/(methanol or ethanol)). Once the dope is cast onto a glass plate, the casting dope is covered to allow controlled solvent evaporation over 45 minutes. Then the cover was removed to allow for 15 minutes of continued solvent evaporation. The film was peeled away from the glass plate, and the film was dried between papers for 2 hours with a weight to avoid curling of the film during the drying process. Then the films were cut to size and dried between metal frames and placed in an over at 100° C. and 120° C. for 10 minutes each. For stretched films, a Brueckner Kario IV was used. The optical properties of the films were measured using a J.A. Woollam Spectroscopic Ellipsometer with CompleteEase analyzing software.

TABLE 10
Films 1.1-1.4 and 2.1-2.6.

| | | | | Stretch | | | |
|---|---|---|---|---|---|---|---|
| | | | d | Temp | Stretch | | |
| Film | CE | Pz (wt %) | (μm) | (° C.) | Ratio | | Haze (%) |
| 1.1 | VM234 | — | 64 | 205 | 1 | × 1.4f | 0.19 |
| 1.2 | VM234 | TPP (10) | 76 | 175 | 1 | × 1.5f | |
| 1.3 | VM234 | CHDM (5) | 70 | 180 | 1 | × 1.4f | |
| 1.4 | VM234 | Admex 6995 | 60 | — | — | | |
| | | (10) | | | | | |
| 2.1 | Ex 6 | — | 74 | 205 | 1 | × 1.4f | 0.33 |
| 2.2 | Ex 6 | TXIB (10) | 58 | 180 | 1 | × 1.5f | |
| 2.3 | Ex 6 | Admex 6995 | 40 | 180 | 1 | × 1.35f | |
| | | (10) | | | | | |
| 2.4 | Ex 6 | DEP (10) | 68 | 184 | 0.73 | × 1.60c | |
| 2.5 | Ex 6 | DEP (15) | 60 | 175 | 1 | × 1.85c | |
| 2.6 | Ex 6 | DEP (20) | 68 | 165 | 1 | × 1.65c | |

The f notation in the stretching ratio means free MD stretching. The c notation in the stretching ratio means constrained MD stretching

TABLE 11
Optical properties of Films 1.1-1.4 and 2.1-2.6.

| | Rₑ [589 nm] | Rₜₕ [589 nm] | Rₑ [450 nm]/ | Re [650 nm]/ | Rₜₕ [450 nm]/ | Rₜₕ [650 nm]/ |
|---|---|---|---|---|---|---|
| Film | (nm) | ₍(nm) | Rₑ [550 nm] | Rₑ [550 nm] | Rₜₕ [550 nm] | Rₜₕ [550 nm] |
| 1.1 | 203 | −108 | 0.94 | 1.03 | 0.95 | 1.03 |
| 1.2 | 175 | −89 | 0.97 | 1.02 | 0.96 | 1.02 |
| 1.3 | 146 | −89 | 0.92 | 1.04 | 0.92 | 1.04 |
| 1.4 | 135 | −128 | 0.93 | 1.04 | 0.95 | 1.03 |
| 2.1 | 196 | −159 | 0.95 | 1.02 | 0.96 | 1.02 |
| 2.2 | 140 | −99 | 0.94 | 1.03 | 0.96 | 1.02 |
| 2.3 | 79.49 | −87.8 | 0.95 | 1.03 | 0.97 | 1.02 |
| 2.4 | 141 | −89 | 0.97 | 1.02 | 0.97 | 1.02 |
| 2.5 | 56.2 | −71.6 | 0.98 | 1.01 | 1.00 | 0.99 |
| 2.6 | 58.1 | −70.2 | 0.98 | 1.01 | 0.99 | 1.00 |

Table 12 provides stability studies of Films 2.7-2.10. Films 2.7 and 2.9 are those that are not treated at 60° C. at 100% RH. Films 2.8 and 2.10 were treated at 60° C. at 100% RH for 144 hours. The film plasticized with DEP, an aromatic plasticizer, and subjected to the heat and humidity conditions for 144 hours (Film 2.10) was more stable than those plasticized with CHDM, a nonaromatic plasticizer, and subjected to the heat and humidity conditions for 144 hours. To be specific, the CHDM plasticized films exhibited large Re, Rth, and % haze changes, while those plasticized with DEP exhibited very little change.

TABLE 12

| | | | | | | | Heat/Humidity |
|---|---|---|---|---|---|---|---|
| | | | | | | | Conditions |
| | | | d | Rₑ [589 nm] | Rₜₕ [589 nm] | Haze | 60° C., |
| Film | CE | Piz (wt %) | (μm) | (nm) | (nm) | (%) | 100% RH |
| 2.7 | Ex 6 | CHDM (10) | 58 | 103.58 | −57.89 | 0.62 | Time = 0 |
| 2.8 | Ex 6 | CHDM (10) | 58 | 140.26 | −79.12 | 4.62 | Time = 144 h |
| 2.9 | Ex 6 | DEP (10) | 72 | 137.4 | −85.55 | 0.91 | Time = 0 |
| 2.10 | Ex 6 | DEP (10) | 70 | 138.47 | −87.22 | 1.22 | Time = 144 h |

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A film comprising a mixed cellulose ester (“MCE”), comprising:
(1) a plurality of acetyl substituents;
(2) a plurality of butyryl substituents; and
(3) a plurality of hydroxyl substituents,
wherein:
the MCE has an average degree of substitution for the acetyl substituents (“DS_{Ac}”) that is from 2.1 to 2.3,
the MCE has an average degree of substitution for the butyryl substituents (“DS_{Bu}”) that is from 0.2 to 0.4,
the MCE has an average degree of substitution for the hydroxyl substituents (“DS_{OH}”) that is from 0.6 to 0.8.

2. The film of claim 1, wherein the sum of DS_{Bu} and DS_{Ac} is from 2.0 to 2.4.

3. (canceled)

4. The film of claim 1, wherein the DSAc is from 2.1 to 2.2.

5. The film of claim 1, wherein the DSOH is from 0.6 to 0.7.

6. The film of claim 1, wherein the film is a reverse dispersion quarter waveplate.

7. The film of claim 1, wherein the film exhibits:
(i) an Rₑ(550 nm) that is in the range of 125 nm to 145 nm,
(ii) an Rₜₕ(550 nm) that is in the range of −65 nm to −100 nm,
(iii) an Rₑ(450 nm)/Rₑ(550 nm) that is in the range of from 0.85 to 0.98,
(iv) an Rₑ(650 nm)/Rₑ(550 nm) that is in the range of from 1.07 to 0.96,
(v) a film thickness (“d”) of from 35 microns to 80 microns, and
(vi) a percent haze of less than 1%,
wherein Rₑ(450 nm), Rₑ(550 nm), and Rₑ(650 nm) are in-plane retardations measured with light wavelengths of 450 nm, 550 nm, and 650 nm, respectively, and Rₜₕ(550 nm) is the out of plane retardation measured with a light wavelength of 550 nm.

8. The film of claim 1, wherein the film is uniaxially, biaxially, or 45 degree stretched.

9. The film of claim 1, wherein the film is biaxially or 45 degree stretched at a ratio of from 0.7 to 1 in the machine direction (“MD”) and 1 to 2 in the transverse direction (“TD”).

10. The film of claim 1, wherein the film further comprises 5 to 25 wt % of a plasticizer comprising an aromatic moiety.

11. The film of claim 10, wherein the plasticizer is a di((C₁₋₁₀)alkyl) phthalate or triphenyl phosphate.

12. The film of claim 1, wherein the film exhibits at least 40% biodegradability at 56 days according to the OECD 301F test method.

13-16. (canceled)

17. A composition comprising:
(A) a mixed cellulose ester (“MCE”), comprising:
(1) a plurality of acetyl substituents;
(2) a plurality of butyryl substituents; and
(3) a plurality of hydroxyl substituents,
wherein:
the MCE has an average degree of substitution for the acetyl substituents (“DS_{Ac}”) that is from 2.1 to 2.3,
the MCE has an average degree of substitution for the butyryl substituents (“DS_{Bu}”) that is from 0.2 to 0.4,
the MCE has an average degree of substitution for the hydroxyl substituents (“DS_{OH}”) that is from 0.6 to 0.8; and
(B) 5 to 30 wt % of a plasticizer, based on the weight of the composition.
